(19) United States
(12) Patent Application Publication
(10) Pub. No.: US 2025/0145434 A1
(43) Pub. Date: May 8, 2025

(54) VERTICAL SLIDING TROLLEY FOR LOAD LIFTING DEVICES AND RESPECTIVE LIFTING DEVICE

(71) Applicant: EUROGAMMA S.P.A., Calenzano (IT)

(72) Inventor: Paolo BARBAGALLO, Prato (IT)

(21) Appl. No.: 18/730,627

(22) PCT Filed: Feb. 8, 2023
(86) PCT No.: PCT/IB2023/051118

§ 371 Date: Jul. 19, 2024

(30) Foreign Application Priority Data
Feb. 17, 2022 (IT) 202022000000620

(51) Int. Cl. B66F 9/08

(52) U.S. Cl. CPC B66F 9/08

(57) ABSTRACT

Described is a trolley with vertical sliding for devices for lifting a load including a first portion and a second portion connected by suitable connecting means, and rolling means designed to engage in relative vertical sliding tracks.

### TECHNICAL FIELD

This invention relates to a trolley with vertical sliding for load lifting devices.

Another object of the invention is a lifting device comprising the above-mentioned trolley with vertical sliding.

In particular, the invention relates to a trolley with vertical sliding designed to be integrated and installed on lifting devices, for example in the railway and automotive sectors.

More in detail, the vertical trolley is applied in column type lifting devices, of the type used for lifting vehicles or in any case bulky objects.

The term trolley means that element of the lifting device designed to engage, entering into direct contact, with a load to be lifted (for example, an automobile or a railway wagon).

The trolley is, therefore, the element which is designed to support the load to be lifted, discharging the forces onto the column of the lifting device on which it is installed and in which it is free to slide vertically in a controlled manner.

### BACKGROUND ART

There are prior art carriages configured for slidably engaging with a vertical column of lifting devices.

According to the currently known solutions, the trolley is made as a single part, or in any case using a hyperstatic structure, and is engaged on the column of the lifting device by four rollers or alternatively four skids.

The four rollers, or skids, are engaged, free to slide on their own axis, on respective guides made directly on the column of the lifting device.

The trolley made in one piece and the presence of four rollers or skids generally determine a system for connection to the hyperstatic column.

This hyperstatic system does not allow optimum use of the actual loading capacity of the four rollers or skids used.

In fact, due to manufacturing tolerances of the column as well as deformations during use of the column under load, of the total of four rollers or skids only three will always and without doubt be loaded whilst one will only be loaded in a random and, therefore, not optimum manner.

This major drawback of the prior art carriages means that during the design phase the four rollers or skids must be sized as if there were only three (the ones actually always under load).

It is understood that this design translates into an inefficient oversizing of the rollers or skids and their respective supports, that is to say, a non-optimum use of all the components of the prior art lifting device in its entirety.

### AIM OF THE INVENTION

The aim of the invention is therefore to overcome the drawbacks of the prior art.

A first aim of the invention is therefore to provide a trolley with vertical sliding for devices for lifting a load which distributes in an optimised manner the load on all the rollers or skids present in the trolley.

A further aim of the invention is to obtain a correct distribution of the load between the various rollers or skids also used in conditions of deformation (elastic or non-elastic) of the respective sliding track.

A further aim is to provide a trolley with vertical sliding for devices for lifting a load which is able to adapt to many conditions of use (different maximum loads which can be lifted) without the need to replace the entire trolley, but only some components of it.

A further aim of the invention is to provide a lifting device comprising a trolley with vertical sliding according to the invention which allows the load to be distributed in an optimised fashion on all the rollers or skids present in the trolley.

The above-mentioned aims are achieved by a trolley with vertical lifting for devices for lifting a load and by a respective lifting device comprising the technical features described in one or more of the appended claims.

Further features and advantages of the invention are more apparent in the non-limiting description which follows of a preferred embodiment of a trolley with vertical sliding for devices for lifting a load according to the invention.

### BRIEF DESCRIPTION OF THE DRAWINGS

The description is set out below with reference to the accompanying drawings which are provided solely for purposes of illustration without restricting the scope of the invention and in which:

FIG. 1 is a schematic side view of a lifting device equipped with a trolley according to the invention;

FIG. 2 is a schematic side view of a trolley with vertically sliding for devices for lifting a load according to the invention and

FIG. 3 is a schematic side view of a detail of the trolley of FIG. 2.

### DETAILED DESCRIPTION

The reference numeral 1 generically denotes a trolley with vertical sliding for devices 100 for lifting a load Q according to the invention, hereinafter also referred to only as the trolley 1.

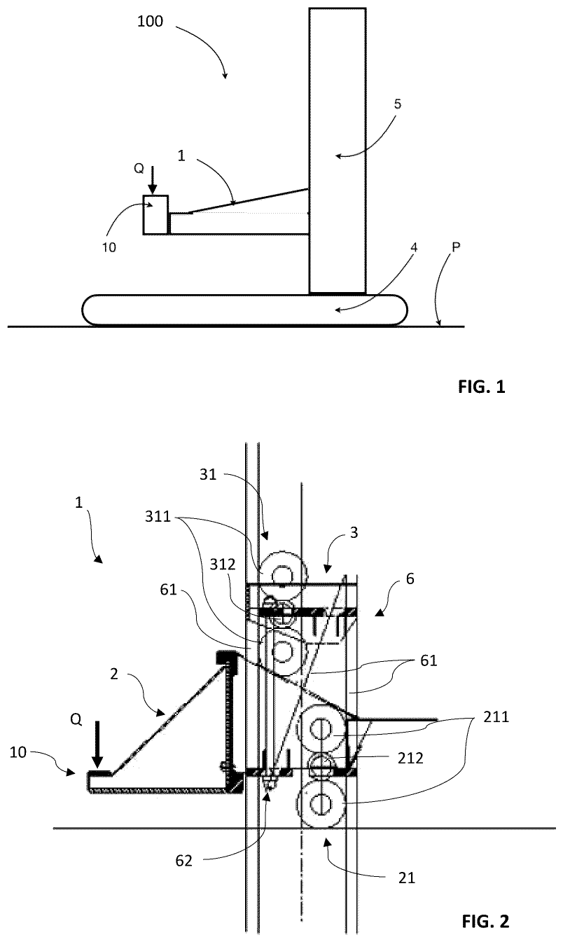

An example embodiment of a lifting device 100 on which is installed a trolley 1 according to the invention is described with reference to FIG. 1.

The lifting device 100 comprises a base support 4 configured to be positioned on a horizontal working plane P.

The support 4 advantageously comprises wheels designed to allow a user to move the device 100 on the plane P.

The lifting device 100 also comprises a column 5 which is fixed on the base support 4 in such a way as to be positioned perpendicular to the horizontal plane P.

In detail, according to the operating configuration, the base support 4 is positioned on a substantially horizontal plane P and the column is, therefore positioned vertically relative to the plane P.

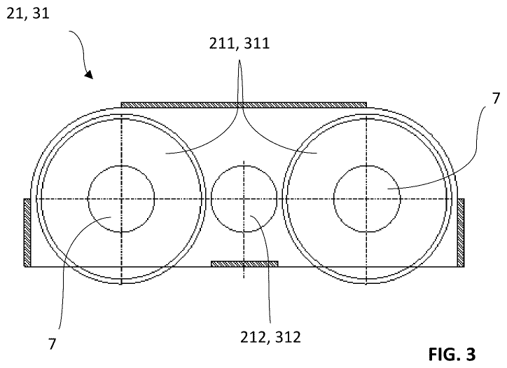

A trolley 1 with vertical sliding for devices 100 for lifting a load Q according to the invention is described with reference to FIGS. 2 and 3.

The trolley 1, according to the invention, is designed to engage with a load Q to be lifted.

Advantageously, in order to make the lifting of the load Q more stable and secure, the trolley comprises means 10 for engagement with the load.

The engagement means 10 are at the end of the trolley 1 opposite to that operatively connected to the column 5.

The trolley 1 therefore adopts a cantilever shape connected with the column 5.

According to the invention, the trolley 1 comprises rolling means 21, 31.

The rolling means 21, 31 are designed to engage in relative vertical sliding tracks made in the lifting device 100 on which the trolley 1 is installed.

Each rolling means 21, 31 engages in a respective vertical sliding track as shown in FIG. 2.

In particular, the vertical sliding tracks are made parallel on the column 5 in such a way that they face towards the trolley 1, according to the invention.

The rolling means 21, 31 each comprise at least two rollers 211, 311 designed to support the load Q acting on the trolley 1.

The above-mentioned rollers 211, 311 are positioned vertically and symmetrically relative to a respective central pivot 212, 312.

These rolling means 21, 31, thanks to their particular shape, represent an efficient solution, which makes it possible to limit the load on each individual roller, and therefore the concentrated load acting locally on the vertical sliding tracks of the lifting device 100.

Moreover, the structure of the rolling means 21, 31 allows them to oscillate relative to an axis passing through the central pivot 212, 312 during operation of the device 100.

In particular, the possibility of oscillating by the rolling means 21, 31 guarantees an equal distribution of the load between the pairs of rollers 211, 311, even in conditions of deformation of the vertical sliding tracks.

Advantageously, by means of the above-mentioned configuration, each roller 211, 311 is always loaded with the relative nominal load and a rolling means 21, 31 is therefore able to carry a load which is double that of a single roller as in the prior art devices, without increasing the stresses on the vertical sliding tracks of the column 5 of the device 100.

According to the embodiment illustrated in the drawings, in detail, the trolley 1 comprises two respective pairs of rollers 211 and two respective pairs of rollers 311, for a total of four rolling means (each of which comprises a respective pair of rollers).

Advantageously, the respective pairs 211, 311 of rollers are aligned with each other in pairs in a horizontal plane (perpendicular to the vertical axis of the column 5).

Therefore, as shown, the pairs of rollers 221 are positioned in a lower position whilst the pairs of rollers 311 are positioned in an upper position, relative to the height of the column 5.

With reference to FIG. 3, the rollers 211, 311 comprise respective pins 7 shaped to match the inside of the rollers 211, 311.

Advantageously, the pins 7 have the same diameter as the above-mentioned pivots 212, 312.

This makes it possible to mount on the central pivots 212, 312 without distinction a single roller (this solution not shown in the drawings) or a pair of rollers (FIGS. 2 and 3), in such a way as to adapt the load which can be supported by the trolley 1 without modifying the structure of the trolley 1.

Advantageously, moreover, all the rollers 211, 311 have the same dimensions.

According to a possible embodiment shown in FIG. 2, the trolley 1 comprises a first lower portion 2 and a second upper portion 3, connected to each other by suitable connecting means 6.

Advantageously, the connecting means 6 comprise a reticular structure designed to connect the first lower portion 2 and the second upper portion 3.

The reticular structure comprises tie rods and struts 61, as shown in the embodiment of FIG. 2.

Due to its very nature, the reticular structure, thanks to its elasticity, allows an effect to be obtained of compensating the position, under load, of the first lower portion 2 with respect to the second upper portion 3 of the trolley 1.

Advantageously, moreover, the tie rods and the struts 61 are connected to the first lower portion 2 and to the second upper portion 3 by respective hinges 62.

The hinges 62 for connecting between the tie rods and the struts 61 of the reticular structure and the respective portions 2, 3 are of the type with at least one degree of freedom.

Advantageously, the hinges 62 comprise ball joints with two or more degrees of freedom.

The presence of the above-mentioned connecting hinges 62 makes it possible to further optimise the effect of compensating the position, under the load Q, of the first lower portion 2 than the second upper portion 3 of the trolley 1 already obtained by adopting the reticular structure as such.

Advantageously, moreover, the reticular structure has a particular lattice type shape.

The trolley 1 with vertically sliding for load lifting devices according to the invention achieves the preset aims and brings further important advantages.

A first advantage of the trolley 1 according to the invention is due to the fact that the presence of rolling means 21, 31 comprising two rollers 211, 311 each, maximises the load which can be supported by the lifting device 100 in its entirety.

Moreover, the structure of the rolling means 21, 31 allowing the assembly of a roller or a pair of rollers without distinction, depending on the load capacity required by the specific application, allows the field of application of the trolley 1 to be further extended to several different loads Q.

A further advantage is due to the fact that the rolling means 21, 31 are able to oscillate with respect to a horizontal axis.

This feature makes it possible to correctly divide the load between the pairs of rollers 211, 311 of the rolling means 21, 31 even under conditions of deformation (elastic or non-elastic) of the vertical sliding tracks.

1. A trolley with vertical sliding for devices for lifting a load comprising respective rolling means designed to engage in respective vertical sliding tracks made on said lifting devices, said trolley being characterised in that said rolling means each comprise at least two rollers designed to support said load acting on said trolley, said rollers being positioned symmetrically relative to a respective central pivot.

2. The trolley according to claim 1, wherein it comprises two pairs of rollers positioned at a same first vertical height as said trolley.

3. The trolley according to claim 1, wherein it comprises two further pairs of rollers positioned at a same second vertical height of said trolley.

4. The trolley according to claim 1, wherein it comprises on a relative end means for engagement with said load to be lifted.

5. The trolley according to claim 1, wherein said rollers comprise respective pins shaped to match the inside of said rollers, and in that said pins and said central pivots have the same diameter as each other.

6. The trolley according to claim 1, wherein said rollers have the same dimensions.

7. The trolley according to claim 1 wherein said at least two rollers oscillate freely relative to a horizontal axis passing through said respective central pivot.

8. The trolley according to claim 1, wherein it comprises a first lower portion and a second upper portion, and means for connecting said first lower portion and second upper portion.

9. The trolley according to claim 8, wherein said connecting means comprise a reticular structure.

10. The trolley according to claim 9, wherein said reticular structure comprises tie rods and struts-connected respectively to said first lower portion and said second upper portion by respective hinges, said hinges being of the type with at least one degree of freedom.

11. The trolley according to claim 10, wherein said hinges comprise spherical joints.

12. The trolley according to claim 9, wherein said reticular structure is of the lattice type.

13. The lifting device comprising a base support configured to be arranged on a horizontal plane and a column fixed on said base support in such a way that it is arranged perpendicular to said horizontal plane, a trolley according to claim 1 slidable vertically on said column and designed to engage with a load to be lifted.
